(19) United States
(12) Patent Application Publication
(10) Pub. No.: US 2026/0061674 A1
(43) Pub. Date: Mar. 5, 2026

(54) INJECTED RUBBER MOLD AND METHOD FOR INJECTED MOLDING RUBBER FOOTWEAR WITH LINING

(71) Applicant: HONESTY RUBBER AND PLASTIC MFG. CO. LTD, Guangzhou (CN)

(72) Inventor: Jiaming ZENG, Guangzhou (CN)

(73) Assignee: HONESTY RUBBER AND PLASTIC MFG. CO. LTD, Guangzhou (CN)

(21) Appl. No.: 19/315,552

(22) Filed: Aug. 30, 2025

(30) Foreign Application Priority Data
Aug. 30, 2024 (CN) 202411216319.8

(51) Int. Cl. B29C 45/14; A43B 1/10; B29C 45/26; B29K 21/00; B29L 31/50

(52) U.S. Cl. CPC B29C 45/14065; B29C 45/26; A43B 1/10; B29C 2045/14155; B29K 2021/003; B29L 2031/501

(57) ABSTRACT

A mold and a method for molding rubber footwear with a lining are provided. The mold includes a combined outer mold and an inner mold. The combined outer mold has a first outer mold and a second outer mold, which are drivable to move towards each other for mold closing and move away from each other for mold opening. The inner mold is covered with a lining and is arranged in the footwear cavity. The inner mold has a guide groove in which a movable insert is slidably arranged. The movable insert has an exposed part that is arranged corresponding to the mold closing part of the combined outer mold, and can be driven to move in the guide groove in different directions, causing the exposed part to retract inwardly, or be flush with or protrude outwardly from the outer surface of the inner mold.

### TECHNICAL FIELD

The present disclosure relates to the technical field of footwear production and, in particular, to a mold and a method for molding rubber footwear with a lining.

### BACKGROUND

A lining is usually required in rubber footwear. However, when a mold is closed to shape the rubber footwear, the lining is prone to being pinched, leading to a series of adverse consequences. First, the aesthetic quality of the footwear may be severely affected. Specifically, the local pinching of the lining may result in defects such as unevenness and wrinkles on the footwear surface, significantly reducing the overall aesthetics of the product and failing to meet consumers' strict requirements for high-quality footwear appearance. Second, the integrity of the lining may be severely damaged. Specifically, the pinched portion of the lining may be torn or damaged, substantially diminishing the inherent functions of the lining such as comfort, breathability, and sweat absorption, and thus severely affecting the wearing comfort and functionality of the footwear. Third, the production efficiency may be significantly reduced. Specifically, once the lining is pinched, cumbersome manual repairs or even remanufacturing are often required, which undoubtedly greatly increases production time and costs, leading to a significant reduction in production efficiency and a substantial increase in production costs for the enterprises. Consequently, it is necessary to improve the existing manufacturing process technology for rubber footwear with a lining.

The above information is provided as background information merely to facilitate understanding of the present disclosure, and it does not determine or acknowledge that any of the above contents can be used as prior art in relation to the present disclosure.

### SUMMARY

It is provided in the present disclosure a mold and a method for molding rubber footwear with a lining to address the issues existing in the conventional technology.

To achieve the above object, the following technical solutions are provided according to the present disclosure.

A rubber injection mold for rubber footwear with a lining is configured to overmold the lining on a footwear body shell. The rubber injection mold includes a combined outer mold and an inner mold.

The combined outer mold includes a first outer mold and a second outer mold, which correspond to a footwear body. The first outer mold and the second outer mold are drivable to move towards each other for mold closing and are drivable to move away from each other for mold opening. A footwear cavity is formed when the combined outer mold is closed, and an inner wall of the first outer mold and an inner wall of the second outer mold define a first footwear body space for accommodating the footwear body shell.

The inner mold is covered with the lining. The inner mold is arranged in the footwear cavity to cooperate with the closed combined outer mold to adhere the lining to a surface of the footwear body shell in the first footwear body space.

The inner mold is provided with a guide groove, in which a movable insert is slidably arranged, the movable insert has an exposed part extending to an outer surface of the inner mold, and the exposed part is arranged corresponding to the mold closing part of the combined outer mold. The movable insert is configured to be driven to: move in the guide groove in a first direction until the exposed part retracts inward of the outer surface of the inner mold; or move in a second direction until the exposed part is flush with or protrudes from the outer surface of the inner mold.

Optionally, the rubber injection mold for rubber footwear with the lining further includes a first pneumatic transmission device and a second pneumatic transmission device, each of which is configured for gas suction or gas blowing.

The first pneumatic transmission device is configured to vacuum or blow gas through the guide groove to drive the movable insert to move in the guide groove in the first direction or in the second direction.

Multiple gas holes are provided at a part, of the inner mold, covered with the lining, and the second pneumatic transmission device is configured to vacuum or blow gas through the gas holes to closely attached the lining to the surface of the inner mold or to expand the lining to separate from the surface of the inner mold.

Optionally, the inner mold is provided with a first gas source interface and a second gas source interface. The inner mold is provided with a first chamber, the first gas source interface is in communication with the first chamber through a first gas flow tube, and the first chamber is in communication with the guide groove. The first gas source interface is connected to the first pneumatic transmission device.

The first pneumatic transmission device is configured to vacuum the first chamber to drive the movable insert to move in the guide groove in the first direction until the exposed part retracts inward of the outer surface of the inner mold; and the first pneumatic transmission device is further configured to blow gas into the first chamber to drive the movable insert to move in the guide groove in the second direction until the exposed part is flush with or protrudes from the outer surface of the inner mold.

Optionally, the combined outer mold involves at least two mold closing parts.

There are at least two movable inserts, which are disposed in one-to-one correspondence with the at least two mold closing parts.

The first gas flow tube is provided with at least two branch tubes, which are disposed in one-to-one correspondence with the at least two movable inserts.

Optionally, the inner mold is provided with a second chamber which is in communication with the multiple gas holes, and the second chamber is isolated from the first chamber. The second gas source interface is in communication with the second chamber through a second gas flow tube, and the second gas source interface is connected to the second pneumatic transmission device.

The second pneumatic transmission device is configured to vacuum the second chamber so as to suction the lining to be tightly attached to the surface of the inner mold; and the second pneumatic transmission device is further configured to blow gas into the second chamber so as to expand the lining to abut against the footwear body shell.

Optionally, the lining has a height greater than that of the footwear body shell.

The inner mold includes a first part where the lining is overlapped with the footwear body shell and a second part where the lining is exposed outside the footwear body shell.

The first part of the inner mold is scaled down proportionally relative to the second part, and the movable insert is arranged at a junction of the first part and the second part.

Alternatively, the first part and the second part of the inner mold are in the same scale, and the movable insert extends from a bottom of the first part to a top thereof and further extends across the junction of the first part and the second part.

Optionally, the footwear cavity has a second footwear body space corresponding to the second part of the inner mold, and a gap between the second footwear body space and the inner mold is greater than a thickness of the lining.

Optionally, a height of the lining is the same as a height of the footwear body shell.

The movable insert extends from a bottom of the inner mold to a top of the inner mold.

Optionally, the combined outer mold further includes a third outer mold, which corresponds to a sole and is located at an end of the first outer mold and the second outer mold.

The combined outer mold forms a footwear cavity during mold closing, and an inner wall of the third outer mold constitutes a sole space for accommodating a sole shell.

Optionally, the inner mold is provided with an avoidance groove, which is positioned to correspond to the mold closing part of the combined outer mold.

A molding method for rubber footwear with a lining is further provided according to the present disclosure, which is carried out with the rubber injection mold according to any one of the above solutions, and the molding method includes:
providing a combined outer mold which has been formed with a footwear body shell;
placing an inner mold covered with a lining into a footwear cavity of the combined outer mold;
driving the movable insert to move in the guide groove in the first direction until the exposed part retracts inward of the outer surface of the inner mold;
closing the combined outer mold;
driving the movable insert to move in the guide groove in the second direction until the exposed part is flush with or protrudes from the outer surface of the inner mold; and
bonding the lining to the footwear body shell and shaping the lining and the footwear body shell under high temperature and high pressure.

Optionally, the movable insert is driven to move in the guide groove in the first direction or in the second direction by vacuuming or blowing gas through the guide groove.

Multiple gas holes are provided at a part, of the inner mold, covered with the lining.

Before the combined outer mold is closed, the method further includes: vacuuming the gas holes to suction the lining to be tightly attached to the surface of the inner mold.

After the combined outer mold is closed, the method further includes: blowing gas through the gas holes to expand the lining until the lining abuts against the footwear body shell.

Optionally, a first pneumatic transmission device and a second pneumatic transmission device are used to independently perform vacuuming or gas blowing operations on the guide groove and the gas holes.

Compared with the conventional technology, the present disclosure has the following beneficial effects.

In the mold and the method for molding rubber footwear with a lining provided by the present disclosure, by providing the inner mold with the movable insert that is movable inwardly or outwardly along the guide groove, the movable insert may be retracted inwardly before the combined outer mold is closed, preventing quality issues caused by the lining being pinched during mold closing. The movable insert can return to a flush or protruding position after the combined outer mold is closed, facilitating a tight bonding between the lining and the footwear body shell. In this way, the present disclosure effectively enhances the quality of rubber footwear with a lining and improves production efficiency.

The present disclosure has other features and advantages that will be apparent from or be illustrated in detail in the accompanying drawings and the following specific embodiments herein, which together serve to explain the specific principles of the present disclosure.

### BRIEF DESCRIPTION OF THE DRAWING

In order to more clearly describe the technical solutions in the embodiments of the present disclosure or in the conventional technology, the accompanying drawings required for describing the embodiments or the conventional technology will be briefly described below. It is apparent that the accompanying drawings described below show merely some embodiments of the present disclosure, and those ordinary skilled in the art may obtained other drawings based on these accompanying drawings without creative effort.

FIG. 1 is a schematic structural view of a combined outer mold of a mold for shaping rubber footwear with a lining according to a first embodiment of the present disclosure;

FIG. 2 is a partial schematic structural view of the combined outer mold of the mold for shaping rubber footwear with a lining according to the first embodiment of the present disclosure;

FIG. 3 is a sectional schematic view of an inner mold of the mold for shaping rubber footwear with a lining according to the first embodiment of the present disclosure;

FIG. 4 is another sectional schematic view of the inner mold of the mold for shaping rubber footwear with a lining according to the first embodiment of the present disclosure; and

FIG. 5 is a flowchart of a method for shaping rubber footwear with a lining according to a second embodiment of the present disclosure;

FIG. 6 is a block diagram showing a combined outer mold according to another embodiment of the present disclosure; and

FIG. 7 is an enlarged view of part of an inner mold according to another embodiment of the present disclosure.

List of reference numerals:

| | |
|---|---|
| 10. combined outer mold; | 101. first outer mold; |
| 102. second outer mold; | 11. first gas source interface; |
| 12. second gas source interface; | 131. first footwear body space; |
| 132. second footwear body space; | 133. parting line; |
| 20. inner mold; | 21. first gas flow tube; |
| 211. branch tube; | 22. second gas flow tube; |
| 23. first chamber; | 24. second chamber; |
| 25. movable insert | 105 footwear cavity; |
| 1 lining; | 3 the footwear body shell; |
| 27 guide groove; | 251 exposed part; |
| 1A first pneumatic transmission | 1B second pneumatic transmission |
| device; | device; |
| 28 gas hole; | 103 mold closing part; |
| 2A first part; | 2B second part; |
| 30 third outer mold; | 32 sole space; |
| 29 avoidance groove. | |

### DETAIL DESCRIPTION OF EMBODIMENTS

To provide a detailed explanation of the possible application scenarios, technical principles, implementable specific solutions, achievable objects, effects of the present disclosure, etc., the specific embodiments will be described below with reference to the accompanying drawings. The embodiments described herein are only for the purpose of more clearly illustrating the technical solutions of the present disclosure and thus are illustrative merely, and should not be construed as limiting the protection scope of the present disclosure.

The term “an embodiment” mentioned herein means at least one embodiment of the present disclosure that may include the specific features, structures or characteristics described in conjunction with the embodiment. The term “embodiment” as used in various places in the specification does not necessarily refer to the same embodiment, and does not specifically limit its independence from or correlation with other embodiments. In principle, in the present disclosure, as long as there is no technical contradiction or conflict, the various technical features mentioned in the embodiments may be combined in any manner to form implementable technical solutions.

Unless otherwise defined, the meanings of the technical terms used herein are the same as those commonly understood by those skilled in the technical field to which this disclosure belongs; and the related terms used herein are merely for describing specific embodiments and are not intended to limit the present disclosure.

In the description of the present disclosure, the expression “and/or” is used to describe the logical relationship between objects, indicating three possible relationships. For example, “A and/or B” means: the existence of A alone, or the existence of B alone, or the existence of both A and B. In addition, the character “/” in the present disclosure generally indicates that there is an “or” logical relationship between the associated objects before and after the character “/”.

In the present disclosure, terms such as “first” and “second” are used merely to distinguish one entity or operation from another entity or operation, and do not necessarily require or imply that there is any actual relationship such as quantity, priority, or sequence between these entities or operations.

Unless expressively limited otherwise, in the present disclosure, the terms “include”, “comprise”, “have” or other similar expressions are intended to cover non-exclusive inclusion, and these expressions do not exclude the possibility that other elements may exist in the process, method or product including the mentioned elements. That is, the process, method or product including a series of elements may not only include those specified elements, but also include other elements not explicitly listed, or elements inherent in such process, method or product.

Consistent with the interpretation in the “Examination Guidelines”, in the present disclosure, expressions such as “greater than”, “less than”, and “exceed” are understood to exclude the reference number itself; and expressions such as “above”, “below”, and “within” are understood to include the reference number itself. In addition, in the description of the embodiments of the present disclosure, the meaning of “multiple” means two or more (inclusive of two), and similar expressions (e.g., “multiple groups”, “multiple times”) related to “multiple” should also be understood in this way, unless otherwise specifically and clearly defined.

In the description of the embodiments of the present disclosure, the spatial-related expressions such as “center”, “longitudinal”, “transverse”, “length”, “width”, “thickness”, “upper”, “lower”, “front”, “rear”, “left”, “right”, “vertical”, “horizontal”, “perpendicular”, “top”, “bottom”, “inner”, “outer”, “clockwise”, “counterclockwise”, “axial”, “radial”, “circumferential” indicate the orientation or positional relationship with reference to the specific embodiments or accompanying drawings, and are merely for the convenience of describing the specific embodiments of the present disclosure or for the reader's understanding, rather than indicating or implying that the device or component referred to must have a specific position, a specific orientation, or be constructed or operated in a specific orientation. Therefore, the spatial-related expressions should not be understood as limiting the embodiments of the present disclosure.

Unless otherwise expressly specified or defined, in the description of the embodiments of the present disclosure, the terms such as “install”, “link”, “connect”, “fix”, “provide” and the like should be understood in a broad sense. For example, the “connection” may be a fixed connection, a detachable connection, or an integrated connection; it may be a mechanical connection, an electrical connection, or a communication connection; it may be a direct connection, or an indirect connection via an intermediate medium; or it may be the internal communication between two components or the interaction between two components. For those skilled in the technical field to which the present disclosure belongs, the meanings of the above terms in the embodiments of the present disclosure can be understood based on specific circumstances.

### First Embodiment

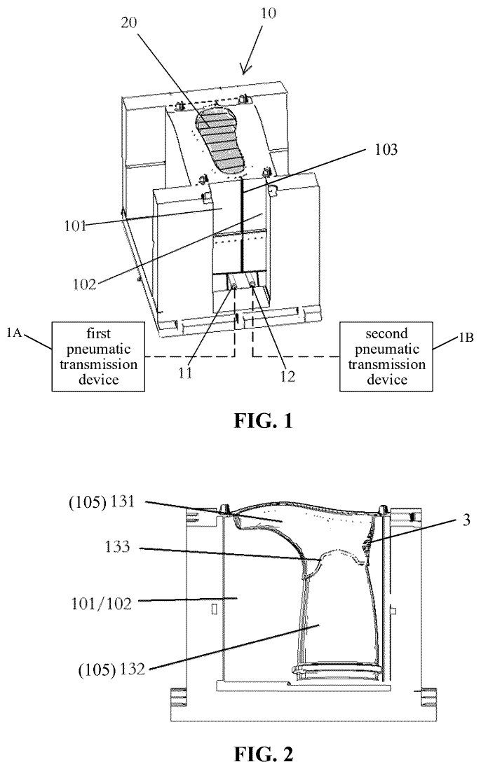

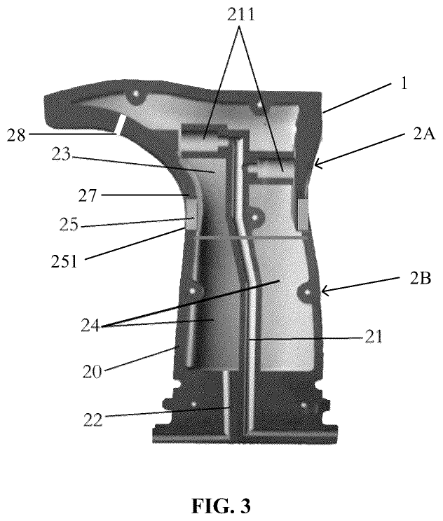

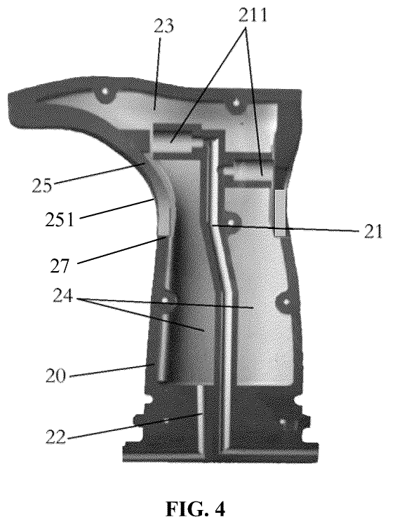

Referring to FIGS. 1 to 4, a rubber injection mold for rubber footwear with a lining is provided according to an embodiment of the present disclosure. The rubber injection mold includes a combined outer mold 10, an inner mold 20, a movable insert 25, and a pneumatic transmission device.

The combined outer mold 10 includes a first outer mold 101 and a second outer mold 102, which are positioned corresponding to a footwear body. The first outer mold 101 and the second outer mold 102 are drivable to move towards each other so as to close the combined outer mold or to move away from each other so as to open the combined outer mold. When the combined outer mold 10 is closed, a footwear cavity 105 is formed, and portions of inner walls of the first outer mold 101 and the second outer mold 102 constitute a first footwear body space 131 for accommodating a footwear body shell 3.

This embodiment may be applied to the rubber injection molding process for rubber footwear. The combined outer mold 10 is provided with a rubber injection port. The first outer mold 101 and the second outer mold 102 are drivable to move towards each other for mold closing or away from each other for mold opening. A footwear cavity 105 is formed when the combined outer mold 10 is closed, and the first footwear body space 131 defined by the inner walls of the first outer mold 101 and the second outer mold 102 is in communication with the rubber injection port. The combined outer mold 10 is configured to inject molten semi-solid rubber into the footwear cavity 105 through a rubber injection vulcanization molding process after it is closed. The first footwear body space 131 is filled with the molten semi-solid rubber under pressure, thereby shaping the footwear body shell 3.

It should be noted that, when rubber is pre-heated to a temperature approaching or reaching its softening point, it may exhibit a semi-solid state with high viscosity, having certain fluidity and deformability. For example, strip-shaped solid rubber is fed into conveying device preheated to a temperature of 30° C. to 40° C. through a feeding port. The strip-shaped solid rubber is softened and then pushed to a high-pressure injection gun. The injection amount and temperature are set by a computer. The rubber is then injected under pressure into the mold cavity, where it undergoes vulcanization at a high temperature of 165° C. and is subsequently shaped. Rubber vulcanization molding refers to the process in which rubber material is transformed into a product with rubber characteristics after being vulcanized and shaped under high temperature and high pressure through vulcanization reaction.

It can be understood that the rubber injection vulcanization mold according to the present disclosure is proposed to achieve shaping of both the lining and the footwear body shell of the rubber footwear, which can effectively improve the bonding strength between the lining and the footwear body shell. In addition, with improvement to the mold, it is possible to prevent the lining from being pinched during mold closing, thereby effectively enhancing the quality of the finished rubber footwear.

In this embodiment, the design enabling relative movement between the first outer mold 101 and the second outer mold 102 facilitates opening and closing of the mold for easy of placement or removal of the footwear body shell. The first footwear body space 131 enables pre-molding or pre-positioning of the footwear body shell, ensuring the positional stability of the footwear body shell during the molding process. This improves the convenience of mold operation, accelerates the speed of molding and demolding during production, and ensures the positional accuracy of the footwear body shell during molding, thereby enhancing product quality.

In this embodiment, the inner mold 20 is covered with the lining 1, and may be disposed in the footwear cavity 105 to cooperate with the closed combined outer mold 10, enabling the lining 1 to adhere to a surface of the footwear body shell 3 in the first footwear body space 131. As a carrier for the lining, the inner mold 20 interacts with the combined outer mold 10 during mold closing to attach tightly the lining 1 to the footwear body shell 3, achieving overmolding. This ensures that the lining fits correctly with the footwear body shell during the molding process, avoiding issues such as inadequate adhesion or misalignment, and thus ensuring the integrity and quality of the product.

The inner mold 20 is provided with a guide groove, and the movable insert 25 is slidably arranged in the guide groove. The movable insert 25 has an exposed part 251 extending to the outer surface of the inner mold 20. The exposed part 251 is arranged corresponding to the mold closing part of the combined outer mold 10. The movable insert 25 may be driven to move in the guide groove in a first direction until the exposed part 251 retracts inward of the outer surface of the inner mold 20, or move in a second direction until the exposed part 251 is flush with or protrudes from the outer surface of the inner mold 20.

By sliding in the guide groove, the movable insert 25 may adjust its position based on different molding stages. Before the mold is closed, the movable insert 25 is retracted inwardly, preventing the lining from being pinched; and after the mold is closed, the movable insert 25 protrudes outwardly from or remains flush with the outer surface of the inner mold 20, facilitating a tight bonding between the lining 1 and the footwear body shell 3. In summary, the provision of the movable insert 25 prevents the lining from being pinched and damaged during the mold closing process, ensuring product quality, and facilitates attachment of the lining 1 to the footwear body shell 3 after mold closing, improving the bonding strength of the final product.

Further, the mold is provided with a first pneumatic transmission device, which includes a vacuum device and a gas source pump. The first pneumatic transmission device may be configured to vacuum or blow gas at the guide groove such as to drive the movable insert 25 to move in the guide groove in the first direction or the second direction under the gas pressure difference. During vacuuming, the movable insert 25 is retracted inwardly in the first direction under negative pressure; or during gas blowing, the movable insert 25 is pushed under the gas pressure to move in the second direction. By provision of the first pneumatic transmission device, the position of the movable insert 25 is precisely controlled with simple and convenient operation, thereby improving the automation level of the production process.

Furthermore, multiple gas holes are provided in the part of the inner mold 20 covered by the lining. The mold is provided with a second pneumatic transmission device, which is configured to vacuum or blow gas at the gas holes such as to attach the lining tightly to the surface of the inner mold 20 or to expand until the lining is separated from the surface of the inner mold 20. By vacuuming or blowing gas at the gas holes, the gas pressure near the gas holes is changed, thereby generating an adsorption or pushing effect on the lining. Specifically, during vacuuming, the lining is adsorbed and tightly attached to the inner mold 20; or during gas blowing, the lining is blown up and expanded.

Before the combined outer mold 10 is closed, the gas holes are vacuumed to adhere the lining tightly to the inner mold 20, ensuring the positional stability of the lining and preventing wrinkles or displacement of the lining. After the combined outer mold 10 is closed, gas is blown through the gas holes to expand the lining so that the lining 1 abuts against the footwear body shell 3, facilitating the tight bonding between the lining 1 and the footwear body shell 3, and thereby improving product quality.

Preferably, the lining is made of Styrene-Butadiene Rubber (SBR) thermal insulation foam cotton, which has excellent abrasion resistance, stretchability, and thermal insulation properties as well as good airtightness and waterproof properties, facilitating effective and sufficient expansion of the lining when gas is blown through the gas holes after the combined outer mold 10 is closed. As a result, the tight bonding between the lining 1 and the footwear body shell 3 is improved.

For example, the lining may be made of WS-2H grade neoprene microporous material as the lining material, which includes 30% neoprene and 70% styrene-butadiene rubber. Thus, the lining is a foamed synthetic rubber product. Due to relatively good insulation and thermal preservation characteristics, the lining may be applied to winter boots.

The inner mold 20 is provided therein with a first chamber 23, and the inner mold 20 is provided with a first gas source interface 11, which is in communication with the first chamber 23 through a first gas flow tube 21. The first chamber 23 is in communication with the guide groove.

The first pneumatic transmission device is configured to vacuum the first chamber 23 so as to drive the movable insert 25 to move in the guide groove in the first direction until the exposed part 251 retracts inward of the outer surface of the inner mold 20; and the first pneumatic transmission device is configured to blow gas into the first chamber 23 so as to drive the movable insert 25 to move in the guide groove in the second direction until the exposed part 251 is flush with or protrudes from the outer surface of the inner mold 20.

In this embodiment, the first chamber 23 serves as an intermediary for gas transmission, and transmits the gas pressure from the first pneumatic transmission device to the guide groove, thereby driving the movable insert 25 to move. By vacuuming or blowing gas into the first chamber 23, the movement of the movable insert 25 is precisely controlled, ensuring the correct position of the movable insert 25 at different production stages, and improving production efficiency and product quality.

Additionally, the inner mold 20 is provided therein with a second chamber 24 which is in communication with the multiple gas holes. The second chamber 24 is isolated from the first chamber 23. The inner mold 20 is provided with a second gas source interface 12, which is in communication with the second chamber 24 through a second gas flow tube 22, and the second gas source interface 12 is connected to the second pneumatic transmission device.

The second pneumatic transmission device is configured to vacuum the second chamber 24 so as to attach the lining tightly to the surface of the inner mold 20; and the second pneumatic transmission device is configured to blow gas into the second chamber 24 so as to blow and expand the lining 1 to abut against the footwear body shell 3. Since the second chamber 24 is independent of the first chamber 23, the pressure adjustment of the gas holes may be independently controlled, thereby adapting to different operations before and after mold closing. This achieves the suction or pushing of the lining, ensuring the independence and accuracy of the suction and expansion of the lining, and improving the positional stability of the lining during the molding process and the bonding between the lining 1 and the footwear body shell 3.

The combined outer mold 10 has at least two mold closed parts, and there are at least two movable inserts 25 disposed in one-to-one correspondence with the at least two mold closing parts 103. In addition, the first gas flow tube 21 has at least two branch tubes 211 disposed in one-to-one correspondence with the at least two movable inserts 25. In this embodiment, the movable inserts 25 are arranged based on various mold closing parts, and the branch tubes 211 are utilized to separately control the movable inserts 25 at the different mold closing parts. This ensures that precise operation may be carried out at multiple mold closing parts, improving the adaptability and reliability of the mold under complex mold closing conditions, and ensuring the molding quality of the lining 1 and the footwear body shell 3 at different positions.

Further, the inner mold 20 is provided with an avoidance groove 29, which is positioned to correspond to the mold closing part 103 of the combined outer mold 10. The avoidance groove 29 is configured to provide an avoidance space for the lining during mold closing. During the vacuuming operation, the lining is moved inwardly into the avoidance groove 29, so as to be prevented from being pinched during mold closing.

Further, in an embodiment, when a semi-rubber footwear is produced, the lining 1 is partially covers the footwear body shell 3, and partially extends to the leg and is exposed outside the footwear body shell. In this case, the inner mold 20 includes a first part 2A where the lining is overlapped with the footwear body shell 3 and a second part 2B where the lining is exposed outside the footwear body shell.

If the lining 1 has a height greater than that of the footwear body shell 3, the first part 2A of the inner mold 20 is scaled down proportionally relative to the second part 2B, and the movable insert 25 is arranged at the junction of the first part 2A and the second part 2B. Since the first part 2A of the inner mold 20 is scaled down proportionally, the portion of the lining corresponding to the footwear body shell is less likely to be pinched. By blowing gas through the gas holes, the lining is tightly bonded to the footwear body shell. Thus, arranging the movable insert 25 at the junction of the first part 2A and the second part 2B is sufficient to ensure a tight bonding between the lining and the footwear body shell at the mold closing part. Meanwhile, when the movable insert 25 protrudes outwardly after mold closing, the space between the first part 2A of the inner mold 20 and the combined outer mold 10 tends to be sealed, facilitating the sufficient expansion of the lining, and thus ensuring a close attachment of the lining to the footwear body shell.

Alternatively, if the height of the lining is greater than that of the footwear body shell, the first part 2A and the second part 2B of the inner mold 20 are designed in the same scale, and the movable insert 25 extends from the bottom of the first part 2A to the top of the first part 2A and further extends across the junction of the first part 2A and the second part 2B, ensuring a tight connection between the lining and the footwear body shell at the mold closing part 103.

In this embodiment, in view of the case that the height of the lining is greater than that of the footwear body shell, the inner mold 20 is partitioned into sections, and the movable insert 25 is positioned based on the structure of the inner mold 20 and production requirements. This ensures molding effect of the lining at different locations, and adapts to the height difference between the lining and the footwear body shell, ensuring a tight bonding between the lining and the footwear body shell at different locations, and thus improving the overall quality of the product.

In an embodiment, if the height of the lining is the same as that of the footwear body shell, the movable insert 25 extends from the bottom of the inner mold 20 to the top of the inner mold 20. In the case that the height of the lining is the same as that of the footwear body shell, the extension of the movable insert 25 may better adapt to the structure and molding requirements of the mold, ensuring a full fit between the lining and the footwear body shell. This enables uniform bonding between the lining and the footwear body shell over the entire height, thereby improving the bonding strength and quality stability of the product.

Further, in this embodiment, the footwear cavity 105 has a second footwear body space 132 corresponding to the second part 2B of the inner mold 20, and a gap between the second footwear body space 132 and the inner mold 20 is greater than a thickness of the lining. A raised parting line 133 is provided between the first footwear body space 131 and the second footwear body space 132, and is configured to cooperate with the combined outer mold 10 and the inner mold 20 when the combined outer mold 10 is closed, so as to close the first footwear body space, thereby facilitating the expansion effect of the lining during gas blowing, and to limit the flow of molten semi-solid rubber during the molding process of the footwear body shell if a semi-rubber footwear is produced. The second footwear body space 132 provides a space for the lining during the molding process, and the gap being larger than the thickness of the lining may prevent the lining from being excessively compressed or obstructed during the molding process, further preventing the lining from being pinched during mold closing. This also ensures that there is a sufficient space for the lining to expand and be applied during the molding process, improving the bonding effect between the lining and the footwear body shell.

In this embodiment, the combined outer mold 10 further includes a third outer mold 30, which corresponds to the footwear sole and is located at an end of the first outer mold 101 and the second outer mold 102. When the combined outer mold 10 is closed to form the footwear cavity, an inner wall of the third outer mold 30 constitutes a sole space 32 for accommodating a sole shell.

It can be understood that, in practical applications, the sole and the footwear body may be formed through rubber injection molding process. A transfer injection partition is arranged on the third outer mold 30, and is provided with a rubber injection port, which is in communication with the sole space and the first footwear body space 131. When injecting the rubber material, the rubber material first fills the sole space and then enters the first footwear body space 131, thereby achieving the molding of the sole shell and the footwear body shell.

In practical applications, the sole shell and the footwear body shell may be made of preformed rubber material made in advance. The preformed rubber material may be formed into a soft rubber material in a specific form, and may be further formed into a hard rubber material under high-temperature and high-pressure condition again.

The provision of the third outer mold enables simultaneous molding of the sole and the footwear body. This achieves integrated molding of the footwear body and the sole, and reduces production steps, thereby improving the integrity and production efficiency of the product.

### Second Embodiment

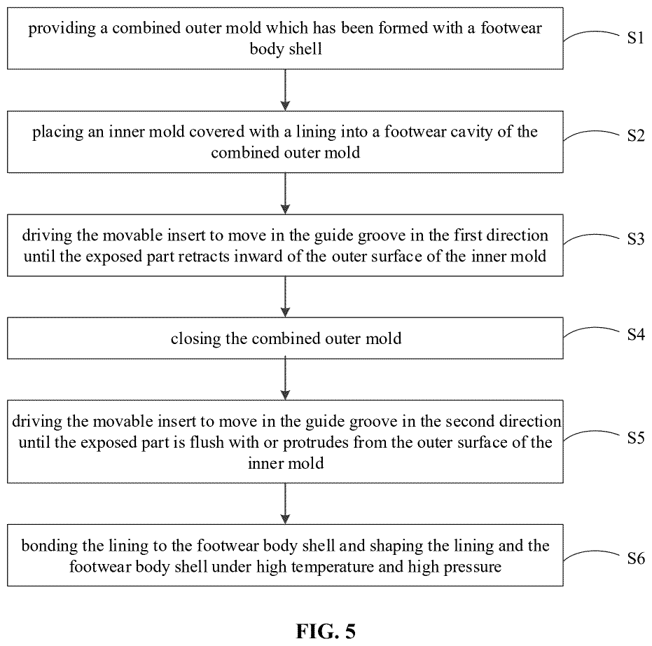

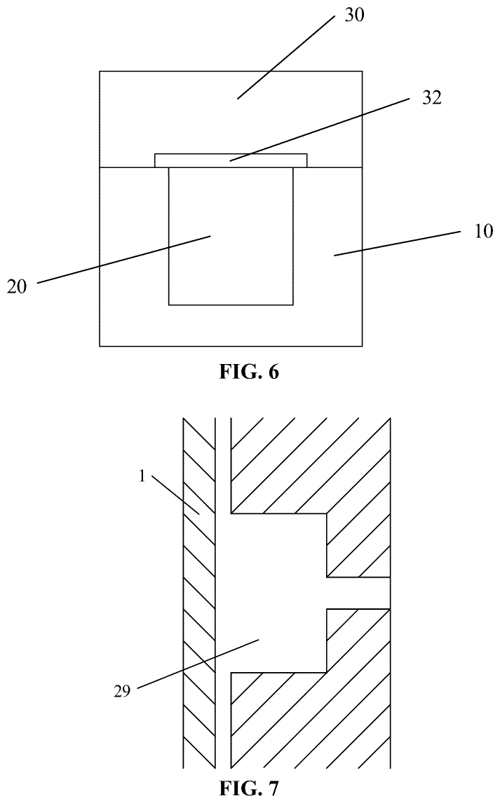

Referring to FIG. 5 together with FIGS. 1 to 4, a method for molding rubber footwear with a lining is provided in this embodiment, which is carried out with the mold as described in any of the above embodiments. The method includes:
S1: providing a combined outer mold 10 which has been formed with a footwear body shell;
S2: placing an inner mold 20 covered with a lining into a footwear cavity of the combined outer mold 10;
S3: driving the movable insert 25 to move in the guide groove in the first direction until the exposed part 251 retracts inward of the outer surface of the inner mold 20;
S4: closing the combined outer mold 10;
S5: driving the movable insert 25 to move in the guide groove in the second direction until the exposed part 251 is flush with or protrudes from the outer surface of the inner mold 20; and
S6: bonding the lining to the footwear body shell and shaping the lining and the footwear body shell under high temperature and high pressure.

In this embodiment, a combined outer mold 10 with a pre-manufactured footwear body shell is firstly provided for ease of subsequent molding operations. Then, an inner mold 20 covered with a lining is placed into the footwear cavity of the combined outer mold 10, so that the lining and footwear body shell are disposed in the same space, preparing for subsequent overmolding, which ensures the proper positioning of the lining and footwear body shell within the mold to facilitate subsequent molding operations. Next, the movable insert 25 is driven to move in the guide groove in the first direction until the exposed part 251 retracts inward of the outer surface of the inner mold 20. By vacuuming the guide groove or in any other driving manner, the movable insert 25 is retracted inwardly to prevent the lining from being pinched during mold closing, thereby preventing damage to the lining during mold closing and ensuring the quality of the product. Subsequently, the combined outer mold 10 is closed by moving the first outer mold 101 and the second outer mold 102 towards each other, thereby closely enclosing the footwear body shell and the lining within the mold, which creates pressure and temperature conditions for molding. This provides the necessary pressure and temperature environment for bonding the lining to footwear body shell, facilitating bonding and molding of the lining and footwear body shell. Next, the movable insert 25 is driven to move in the guide groove in the second direction until the exposed part 251 is flush with or protrudes from the outer surface of the inner mold 20. By blowing gas through the guide groove or in any other driving manner, the movable insert 25 is moved to be flush with or protrude from the outer surface of the inner mold 20, which facilitates a tight bonding between the lining and the footwear body shell, ensuring close adhesion between them during the molding process, and improving the bonding strength and quality of the product. Finally, under high temperature and high pressure, the lining and the footwear body shell are bonded and shaped. The high temperature and high pressure accelerate the crosslinking and curing of the rubber material, so that the lining and the footwear body shell are firmly bonded together, which achieves efficient bonding between them, thereby enhancing the integrity and durability of the product.

Further, in this embodiment, the movable insert 25 is driven to move in the guide groove in the first or second direction by vacuuming or blowing gas through the guide groove.

Furthermore, multiple gas holes 28 are provided at the part of the inner mold 20 covered by the lining 1.

Before the combined outer mold 10 is closed, the molding method further includes: vacuuming the gas holes 28 to draw the lining to tightly abut against the surface of the inner mold 20.

After the combined outer mold 10 is closed, the molding method further includes: blowing gas through the gas holes 28 to expand the lining until the lining abuts against the footwear body shell.

As stated above, the molding method according to the present disclosure includes: before the combined outer mold 10 is closed, vacuuming the gas holes 28 to suction the lining to tightly abut against the surface of the inner mold 20; and after the combined outer mold 10 is closed, blowing gas through the gas holes 28 to expand the lining until the lining abuts against the footwear body shell. By vacuuming and blowing gas through the gas holes 28, the gas pressure near the lining is changed, enabling position adjustment of the lining at different stages and facilitating a tight bonding between the lining and the footwear body shell. This ensures the stable positioning of the lining before mold closing and facilitates tight adhesion between the lining and the footwear body shell after mold closing, thereby improving the quality of the product.

In this embodiment, a first pneumatic transmission device 1A and a second pneumatic transmission device 1B are used to independently perform vacuuming or gas blowing operations on the guide groove 27 and the gas holes 28. The independent pneumatic transmission devices enables precise and separate control of the gas pressure in the guide groove 27 and the gas holes 28, preventing mutual interference and improving operational accuracy and reliability. This ensures precise control of the movable insert 25 and the lining during the molding process, thereby improving production efficiency and product quality.

It should be noted that the above embodiments have been illustrated in the specification and drawings of the present disclosure, but should not be construed as limiting the protection scope of the present disclosure. Any technical solution derived from equivalent structural or process replacements or modifications based on the substantive concepts of the present disclosure, utilizing the contents described in the specification and drawings of the present disclosure, as well as any technical solutions of the above embodiments implemented directly or indirectly in other related technical fields, shall fall within the protection scope of the present disclosure.

1. A rubber injection mold for rubber footwear with a lining, wherein the rubber injection mold is configured to overmold the lining on a footwear body shell, and the rubber injection mold comprises:
a combined outer mold, comprising a first outer mold and a second outer mold which correspond to a footwear body, wherein the first outer mold and the second outer mold are drivable to move towards each other so as to close the combined outer mold and are drivable to move away from each other so as to open the combined outer mold, wherein the combined outer mold forms a footwear cavity when the combined outer mold is closed, and an inner wall of the first outer mold and an inner wall of the second outer mold define a first footwear body space for accommodating the footwear body shell; and
an inner mold, covered with the lining, wherein the inner mold is configured to be placed in the footwear cavity and cooperate with the closed combined outer mold to adhere the lining to a surface of the footwear body shell in the first footwear body space,
wherein the inner mold is provided with a guide groove, in which a movable insert is slidably arranged, the movable insert has an exposed part extending to an outer surface of the inner mold, and the exposed part is arranged corresponding to the mold closing part of the combined outer mold, and
wherein the movable insert is configured to be driven to: before the combined outer mold is closed, move in the guide groove in a first direction until the exposed part retracts inward of the outer surface of the inner mold, providing a space for the lining to keep away from the combined outer mold when the combined outer mold is closed; and after the combined outer mold is closed, move in a second direction until the exposed part is flush with or protrudes from the outer surface of the inner mold, enabling the lining to be closely attached to the footwear body shell.

2. The rubber injection mold for rubber footwear with the lining according to claim 1, wherein
the rubber injection mold further comprises a first pneumatic transmission device and a second pneumatic transmission device, each of which is configured for gas suction or gas blowing,
the first pneumatic transmission device is configured to vacuum or blow gas through the guide groove so as to drive the movable insert to move in the guide groove in the first direction or in the second direction, and
a plurality of gas holes are provided at a part of the inner mold covered with the lining, and the second pneumatic transmission device is configured to vacuum or blow gas through the gas holes so as to closely attached the lining to the surface of the inner mold or to expand the lining to separate from the surface of the inner mold.

3. The rubber injection mold for rubber footwear with the lining according to claim 2, wherein
the inner mold is provided with a first gas source interface and a second gas source interface,
the inner mold is provided with a first chamber, the first gas source interface is in communication with the first chamber through a first gas flow tube, the first chamber is in communication with the guide groove, and the first gas source interface is connected to the first pneumatic transmission device,
the first pneumatic transmission device is configured to vacuum the first chamber so as to drive the movable insert to move in the guide groove in the first direction until the exposed part retracts inward of the outer surface of the inner mold, and
the first pneumatic transmission device is further configured to blow gas into the first chamber so as to drive the movable insert to move in the guide groove in the second direction until the exposed part is flush with or protrudes from the outer surface of the inner mold.

4. The rubber injection mold for rubber footwear with the lining according to claim 3, wherein
the combined outer mold comprises at least two mold closing parts,
there are at least two movable inserts, which are disposed in one-to-one correspondence with the at least two mold closing parts, and
the first gas flow tube comprises at least two branch tubes, which are disposed in one-to-one correspondence with the at least two movable inserts.

5. The rubber injection mold for rubber footwear with the lining according to claim 3, wherein
the inner mold is provided with a second chamber which is in communication with the plurality of gas holes, and the second chamber is isolated from the first chamber,
the second gas source interface is in communication with the second chamber through a second gas flow tube, and the second gas source interface is connected to the second pneumatic transmission device,
the second pneumatic transmission device is configured to vacuum the second chamber so as to suction the lining to be tightly attached to the surface of the inner mold, and
the second pneumatic transmission device is further configured to blow gas into the second chamber so as to expand the lining to abut against the footwear body shell.

6. The rubber injection mold for rubber footwear with the lining according to claim 1, wherein
the lining has a height greater than that of the footwear body shell,
the inner mold comprises a first part where the lining is overlapped with the footwear body shell and a second part where the lining is exposed outside the footwear body shell,
the first part of the inner mold is scaled down proportionally relative to the second part, and the movable insert is arranged at a junction of the first part and the second part; or, the first part and the second part of the inner mold are in the same scale, and the movable insert extends from a bottom of the first part to a top thereof and further extends across the junction of the first part and the second part.

7. The rubber injection mold for rubber footwear with the lining according to claim 6, wherein
the footwear cavity has a second footwear body space corresponding to the second part of the inner mold, and a gap between the second footwear body space and the inner mold is greater than a thickness of the lining,
a raised parting line is provided between the first footwear body space and the second footwear body space, and is configured to cooperate with the combined outer mold and the inner mold when the combined outer mold is closed, so that the first footwear body space forms a closed space.

8. The rubber injection mold for rubber footwear with the lining according to claim 1, wherein a height of the lining is the same as a height of the footwear body shell, and the movable insert extends from a bottom of the inner mold to a top of the inner mold.

9. The rubber injection mold for rubber footwear with the lining according to claim 1, wherein
the combined outer mold further comprises a third outer mold, which corresponds to a sole and is located at an end of the first outer mold and the second outer mold, and
the combined outer mold forms a footwear cavity when the combined outer mold is closed, and an inner wall of the third outer mold constitutes a sole space for accommodating a sole shell.

10. The rubber injection mold for rubber footwear with the lining according to claim 1, wherein the inner mold is provided with an avoidance groove, which is positioned to correspond to the mold closing part of the combined outer mold.

11. A method for molding rubber footwear with a lining, which is carried out with the rubber injection mold according to claim 1, wherein the method comprises:
providing a combined outer mold which has been formed with a footwear body shell;
placing an inner mold covered with a lining into a footwear cavity of the combined outer mold;
driving the movable insert to move in the guide groove in the first direction until the exposed part retracts inward of the outer surface of the inner mold;
closing the combined outer mold;
driving the movable insert to move in the guide groove in the second direction until the exposed part is flush with or protrudes from the outer surface of the inner mold; and
bonding the lining to the footwear body shell and shaping the lining and the footwear body shell under high temperature and high pressure.

12. The method for molding rubber footwear with the lining according to claim 11, wherein
the movable insert is driven to move in the guide groove in the first direction or in the second direction by vacuuming or blowing gas through the guide groove;
a plurality of gas holes are provided at a part of the inner mold covered with the lining;
before the combined outer mold is closed, the method further comprises: vacuuming the gas holes to suction the lining to be tightly attached to the surface of the inner mold; and
after the combined outer mold is closed, the method further comprises: blowing gas through the gas holes to expand the lining until the lining abuts against the footwear body shell.

13. The method for molding rubber footwear with the lining according to claim 12, wherein a first pneumatic transmission device and a second pneumatic transmission device are used to independently perform vacuuming or gas blowing operations on the guide groove and the gas holes.
